(19) United States
(12) Patent Application Publication
(10) Pub. No.: US 2016/0251810 A1
(43) Pub. Date: Sep. 1, 2016

(54) SYSTEM AND METHOD FOR LEVELING RECLAIMED WORK SURFACES

(71) Applicant: Caterpillar Paving Products Inc., Brooklyn Park, MN (US)

(72) Inventors: Brian J. Schlenker, Shoreview, MN (US); John E. Jorgensen, Andover, MN (US); Jason W. Muir, Andover, MN (US); Eric S. Engelmann, Delano, MN (US)

(73) Assignee: Caterpillar Paving Products Inc., Brooklyn Park, MN (US)

(21) Appl. No.: 14/633,187

(22) Filed: Feb. 27, 2015

(51) Int. Cl. E01C 23/06; B01F 15/02; E01C 21/00; B01F 7/00

(52) U.S. Cl. CPC E01C 23/065; B01F 7/00; B01F 15/026; E01C 21/00

(57) ABSTRACT

A rotary mixer for leveling a work surface includes an attachment device configured to be detachably coupled to a frame of the rotary mixer and an implement detachably coupled to the attachment device. The rotary mixer further includes an actuator configured to move the attachment device between a first position and a second position relative to the frame. The implement is configured to be in contact with the work surface in the second position of the attachment device to level the work surface during operation of the rotary mixer.

### TECHNICAL FIELD

The present disclosure relates to a system and a method for leveling a reclaimed work surface prepared by a rotary mixer.

### BACKGROUND

Machines, such as a rotary mixer may be used as a soil stabilizer to cut, mix, and pulverize soils with additives or aggregates to modify and stabilize the soil for a strong base. The rotary mixer may also be used as a road reclaimer to pulverize a surface layer, such as asphalt, and mix with an underlying base to create a new road surface and stabilize deteriorated roadways. The rotary mixer includes a mixing chamber and multiple rotors to reclaim and pulverize such work surfaces. The reclaimed material that is dispensed from the mixing chamber may be left uneven by rear wheels of the machine. Hence, the uneven surface formed behind the machine may need to be leveled before compacting the work surface depending on the work surface and a jobsite.

US Patent Publication Number 2005/0111922 (the '922 patent) discloses a method of producing soil based material and improving qualities of the soil. The '922 patent is further concerned with improving load bearing qualities and impact loading qualities of the soil. The soil based material includes synthetic fibers scattered throughout the soil matrix and may include additives such as resilient particle also scattered throughout the soil matrix. The '922 patent further includes a freely rotatable roller drawn behind a machine for restoring the surface to a flat and a level condition. The roller may cause additional load on the machine. Further, the roller may not be adjusted to different heights relative to the surface for leveling the surface as the roller is in continuous contact with the surface.

### SUMMARY OF THE DISCLOSURE

In one aspect of the present disclosure, a system associated with a rotary mixer is provided. The rotary mixer includes a mixing chamber and a plurality of rotors rotatably disposed within the mixing chamber for reclaiming material from a work surface. The system includes an attachment device configured to be detachably coupled to a frame of the rotary mixer. The system further includes one or more actuators configured to be coupled between the attachment device and the frame. The one or more actuators are further configured to move the attachment device between a first position and a second position relative to the frame. The system further includes an implement detachably coupled to the attachment device. The implement is configured to be in contact with the work surface in the second position of the attachment device to level the reclaimed material left behind the rotary mixer during operation of the rotary mixer.

In another aspect of the present disclosure, a rotary mixer is provided. The rotary mixer includes a mixing chamber and a plurality of rotors rotatably disposed within the mixing chamber for reclaiming material from a work surface. The rotary mixer includes a frame and an attachment device configured to be detachably coupled to the frame. The attachment device is further configured to couple to an implement. The rotary mixer further includes one or more actuators configured to be coupled between the attachment device and the frame. The one or more actuators are further configured to move the attachment device between a first position and a second position relative to the frame. The implement is configured to be in contact with the work surface in the second position of the attachment device to level the reclaimed material left behind the rotary mixer during operation of the rotary mixer.

In yet another aspect of the present disclosure, a method of leveling a work surface prepared by a rotary mixer is provided. The rotary mixer includes a mixing chamber and a plurality of rotors rotatably disposed within the mixing chamber for reclaiming material from the work surface. The method includes coupling an attachment device to a frame of the rotary mixer. The attachment device is detachably coupled to the frame. The method further includes coupling an implement to the attachment device. The implement is detachably coupled to attachment device. The method further includes actuating the attachment device to move between a first position and a second position via one or more actuators. In the second position, the implement is configured to be in contact with the work surface to level the reclaimed material left behind the rotary mixer during operation of the rotary mixer.

Other features and aspects of this disclosure will be apparent from the following description and the accompanying drawings.

### BRIEF DESCRIPTION OF THE DRAWINGS

FIG. 1 is a side view of a rotary mixer associated with a system for leveling a work surface, according to an embodiment of the present disclosure;

FIG. 2 is a perspective view showing a rear end of the rotary mixer, according to an embodiment of the present disclosure;

FIG. 3 is a perspective view of an attachment device associated with the system, according to an embodiment of the present disclosure;

FIG. 4 is a perspective view of a base member of the attachment device, according to an embodiment of the present disclosure; and

FIG. 5 is a method of leveling the work surface, according to an embodiment of the present disclosure.

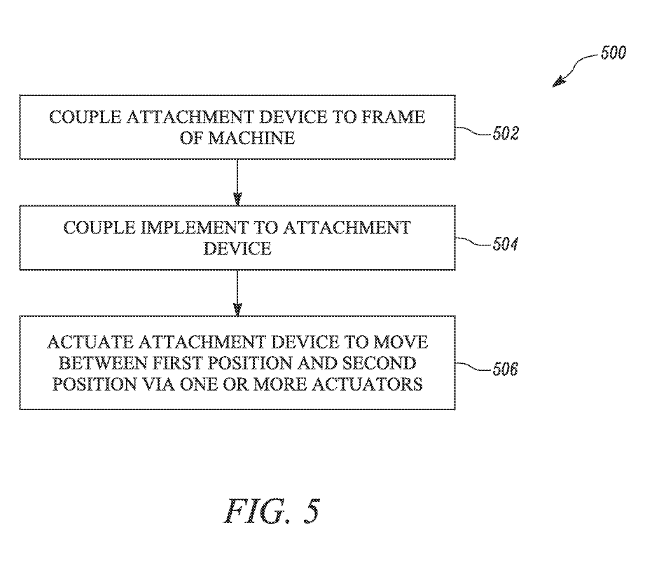

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

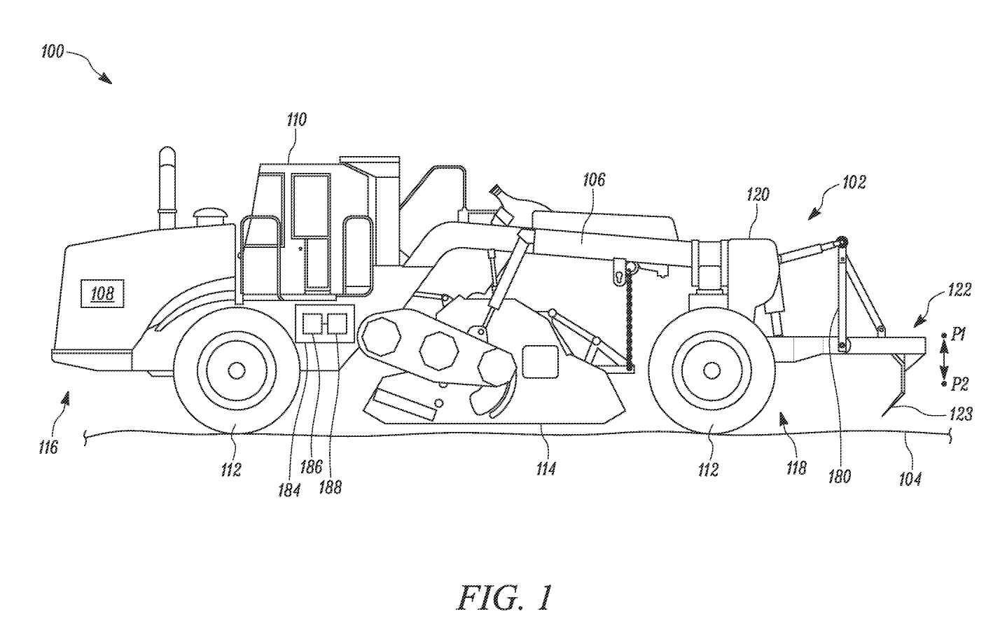

FIG. 1 shows a side view of a rotary mixer 100 associated with a system 102 for leveling a work surface 104, according to an embodiment of the present disclosure. The rotary mixer 100 may be used for preparing a ground surface or a soil bed for various purposes such as construction of roads and buildings, and also for various applications, such as agriculture.

The rotary mixer 100 includes a frame 106 to support various components of the rotary mixer 100, such as a power source 108, a power train (not shown), an operator cab 110, ground engaging members 112 and a mixing chamber 114. The ground engaging members 112 include a pair of front ground engaging members 112 disposed adjacent to a front end 116 and a pair of rear ground engaging members 112 disposed at a rear end 118 of the rotary mixer 100. In the illustrated embodiment, the ground engaging members 112 are wheels. In other embodiments, at least one of the pair of front and the rear ground engaging members 112 may be a track. The ground engaging members 112 may be powered by the power source 108 through the power train. The power source 108 may be disposed adjacent to the front end 116 of the rotary mixer 100. In an example, the power source 108 may be an internal combustion engine.

The mixing chamber 114 is disposed between the pairs of the front and the rear ground engaging members 112 and may be supported on the frame 106. The mixing chamber 114 may include a plurality of rotors (not shown) rotatably disposed within the mixing chamber 114. The rotors may also be powered by the power source 108 through the power train. The mixing chamber 114 may be used for soil preparations, such as road reclamation, soil stabilization, surface pulverization, and the like. The mixing chamber 114 may further include a front door (not shown) and a rear door (not shown) to selectively exit reclaimed material. The front and the rear doors may be further configured to provide optimum control of gradation and material uniformity. The front and rear doors may be actuated by one or more hydraulic actuators (not shown).

The system 102 includes an attachment device 120 detachably coupled to the frame 106 of the rotary mixer 100 adjacent to the rear end 118 thereof. The system 102 further includes an implement 122. The implement 122 is detachably coupled to the attachment device 120. The implement 122 may include a work tool 123. In an example, the work tool 123 may be a blade. In other examples, the work tool 123 may be a roller or any other work tool known in the art. The implement 122 may be raised and lowered with reference to the work surface 104 by the attachment device 120 to selectively level the work surface 104. The reclaimed material coming out from the mixing chamber 114 may make the work surface 104 uneven due to the pair of rear ground engaging members 112 during operation of the rotary mixer 100. The attachment device 120 may be actuated to level the reclaimed material left behind the rotary mixer 100 via the implement 122 during operation of the rotary mixer 100.

The operator cab 110 may include a control console (not shown). The control console may include various operating control levers, switches, and the like for controlling forward and backward directions of the rotary mixer 100, operation of the rotors within the mixing chamber 114 and actuation of the attachment device 120.

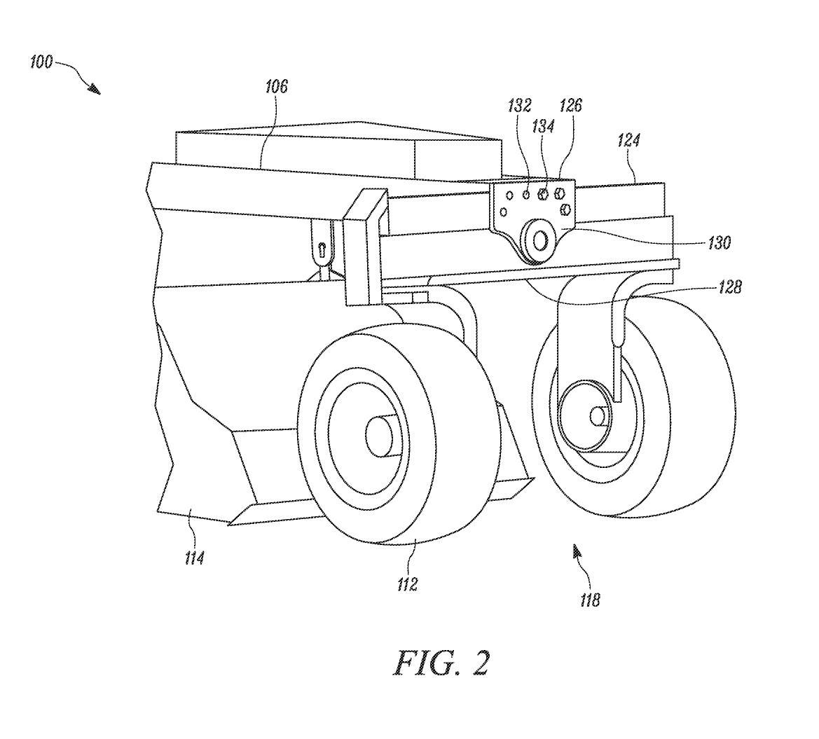

FIG. 2 shows a perspective view of the rear end 118 of the rotary mixer 100, according to an embodiment of the present disclosure. The frame 106 may include a transverse member 124 adjacent to the rear end 118 of the rotary mixer 100. The frame 106 further includes a mounting member 126 coupled to the transverse member 124. The mounting member 126 may be configured to pivotally couple an axle 128 to the pair of rear ground engaging members 112. In the illustrated embodiment, the mounting member 126 may include a surface 130 adapted to detachably couple with the attachment device 120. In an alternative embodiment, the attachment device 120 may be detachably coupled to the transverse member 124 of the frame 106.

In an embodiment, the mounting member 126 further includes a plurality of holes 132 defined on the surface 130 thereof. Each of the holes 132 is configured to engage with a fastening member 134. The fastening members 134 may be threadingly engaged with the corresponding holes 132. In an example, the fastening member 134 may be a bolt or a bolt stud. In FIG. 2, some of the fastening members 134 disposed in the holes 132 is shown for illustration purpose. In an alternative embodiment, the fastening members 134 may be integrally formed with the mounting member 126. In such a case, the fastening members 134 may extend vertically from the surface 130 of the mounting member 126. Further, the fastening member 134 may include threads to engage with a nut. Although, aforesaid fastening members 134 are used to couple the attachment device 120 with the mounting member 126 of the frame 106, it may be contemplated that any known method of fastening may be adapted for detachably coupling the attachment device 120 with the mounting member 126.

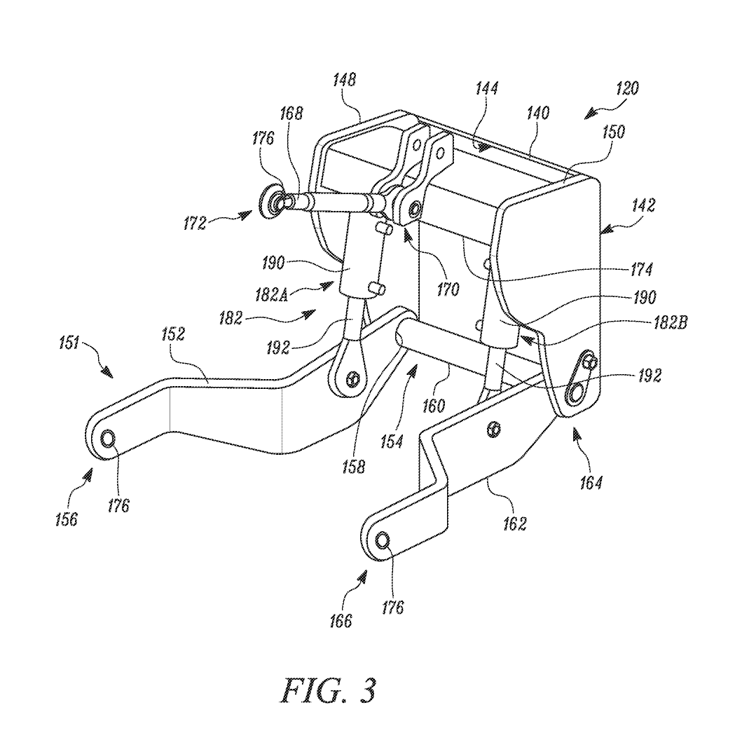

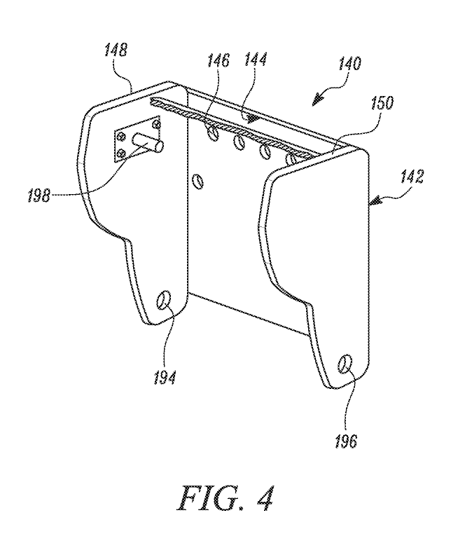

FIG. 3 shows a perspective view of the attachment device 120, according to an embodiment of the present disclosure. The attachment device 120 includes a base member 140 configured to be coupled to the frame 106 of the rotary mixer 100. The base member 140 may include a first surface 142 configured to engage with the surface 130 of the mounting member 126. The base member 140 may further include a second surface 144 distal to the first surface 142. The base member 140 further includes a plurality of holes 146 (shown in FIG. 4) extending between the first surface 142 and the second surface 144. It may be contemplated that the number of holes 146 defined in the base member 140 may correspond to the number of holes 132 defined in the mounting member 126. Each of the holes 146 is configured to receive the corresponding fastening member 134. The attachment device 120 further includes one or more link members 151 pivotally coupled to the base member 140. The one or more link members 151 are configured to couple to the implement 122.

In an example, the base member 140 may include a first leg member 148 extending from the second surface 144 thereof. The first leg member 148 may extend vertically from the second surface 144. The base member 140 may further include a second leg member 150 spaced apart from the first leg member 148. The second leg member 150 may also extend from the second surface 144 of the base member 140.

As shown in FIG. 3, the link members 152 may include a first lower link 152, a second lower link 162 and a top link 168. The first and the second lower links 152, 162 and the top link 168 are described in detail below for illustration purpose of the present disclosure. However, it should be understood that one of the first and the second lower links 152, 162 and the top link 168 may also be used for performing intended purpose of the present disclosure.

The first lower link 152 may be pivotally coupled to the base member 140. The first lower link 152 may include a first end 154 and a second end 156. The first end 154 may include an aperture 158 configured to receive a rod member 160. The rod member 160 may be configured to rotatably couple the first end 154 of the first lower link 152 with the first leg member 148. The attachment device 120 may further include the second lower link 162 pivotally coupled to the base member 140. Similar to the first lower link 152, the second lower link 162 may also include a first end 164 and the second end 166. The first end 164 may be rotatably coupled to the second leg member 150 via the rod member 160. Thus, the first and second lower links 152, 162 may be moveably coupled to the base member 140 of the attachment device 120.

The attachment device 120 may further include the top link 168 spaced apart from the first lower link 152 and the second lower link 162. The top link 168 may be pivotally coupled to the base member 140. The top link 168 may include a first end 170 and a second end 172. The first end 170 of the top link 168 may be pivotally coupled to an intermediate member 174. The intermediate member 174 may be connected between the first leg member 148 and the second leg member 150. The aforesaid description of coupling the first and the second lower links 152, 162, and the top link 168 with the base member 140 may be exemplary, and it may be contemplated that any known method of coupling may be adapted to movably couple the first and the second lower links 152, 162, and the top link 168 with the base member 140.

Each of the second ends 156, 166, 172 of the first lower link 152, the second lower link 162 and the top link 168, respectively, may define a pin hole 176. The pin holes 176 of each of the first lower link 152, the second lower link 162 and the top link 168 may be adapted to couple to a 3-point hitch member 180 (shown in FIG. 1). The 3-point hitch member 180 may be further coupled to the implement 122. It may also be contemplated that the 3-point hitch member 180 may be an integral component of the implement 122. In an example, the implement 122 may be a rear blade, a box blade, or any other leveling implement known in the art.

The attachment device 120 further includes one or more actuators 182 coupled between at least one of the first and second lower links 152, 162. The actuators 182 are configured to move at least one of the first and second lower links 152, 162 between a first position ‘P1’ (shown in FIG. 1) and a second position ‘P2’ (shown in FIG. 1) relative to the frame 106. As shown in FIG. 3, the attachment device 120 may include a first actuator 182A coupled between the first leg member 148 and the first lower link 152 and a second actuator 182B coupled between the second leg member 150 and the second lower link 162.

In an embodiment, the first and second actuators 182A, 182B may be a hydraulic actuator powered by a hydraulic system 184 (shown in FIG. 1) of the rotary mixer 100. In another embodiment, the first and the second actuators 182A, 182B may be an electric actuator powered by an electric system (not shown) of the rotary mixer 100. The hydraulic system 184 includes a reservoir 186 (shown in FIG. 1) for containing fluid therein. The reservoir 186 may be disposed adjacent to the front end 116 of the rotary mixer 100 and supported on the frame 106. The reservoir 186 may be an existing reservoir used for operating various other hydraulic systems, such as a steering system and a hydraulic system used for actuating the mixing chamber 114 of the rotary mixer 100.

The hydraulic system 184 further includes one or more control valves 188 (shown in FIG. 1) disposed between the actuators 182 and the reservoir 186. The control valves 188 may be configured to selectively allow a flow of fluid to the actuators 182 from the reservoir 186 so as to move the first and the second lower links 152, 162 between the first position ‘P1’ and the second position ‘P2’. The control valves 188 may be actuated by one or more control levers disposed within the operator cab 110. It may also be contemplated that the hydraulic system 184 may include various hydraulic elements including, but not limited to, a pump, pressure relief valves and check valves disposed between the actuators 182 and the reservoir 186 for controlling the flow of fluid within the hydraulic system 184. The pump may be powered by the power source 108 to supply pressurized fluid to the actuators 182.

In an embodiment, the first and the second actuators 182A, 182B may be configured to fluidly communicate with the hydraulic system 184. In an example, the first and the second actuators 182A, 182B may be a double acting cylinder. The first actuator 182A is illustrated in detail for illustration purpose of the present disclosure. The first actuator 182A may include a cylinder 190 coupled to the first leg member 148 and a piston rod 192 coupled to the first lower link 152. The piston rod 192 may be slidably disposed within the cylinder 190 to move between an extended position and a retracted position. The retracted position and the extended position may correspond to the first position ‘P1’ and the second position ‘P2’, respectively, of the first and second lower links 152, 162. The piston rod 192 may move between the retracted and the extended position based on an actuation of the control valves 188 of the hydraulic system 184. The control valves 188 may be actuated based on an input from an operator.

FIG. 4 shows a perspective view of the base member 140 of the attachment device 120, according to an embodiment of the present disclosure. The first leg member 148 may include a first opening 194 configured to receive the rod member 160 therethrough. Similarly, the second leg member 150 may include a second opening 196 coaxial to the first opening 194 configured to receive the rod member 160 therethrough. Thus, the rod member 160 may be disposed between the first and second leg members 148, 150 to movably couple the first and the second lower links 152, 162 with the base member 140.

The first leg member 148 may further include a first pin member 198 spaced apart from the first opening 194. The first pin member 198 may be configured to couple the first actuator 182A. Similarly, the second leg member 150 may include a second pin member (not shown) spaced apart from the second opening 196. The second pin member may be configured to couple the second actuator 182B. Thus, the first and the second lower links 152, 162 may be movable between the first position ‘P1’ and the second position ‘P2’. In various embodiments, the first and the second actuators 182A, 182B may be coupled to the transverse member 124 of the frame 106 to move the first and the second lower links 152, 162 between the first position ‘P1’ and the second position ‘P2’. The aforesaid description of coupling the first and the second actuators 182A, 182B with the base member 140 may be exemplary, and it may be contemplated that any known method of coupling may be adapted.

### INDUSTRIAL APPLICABILITY

The present disclosure relates to the system 102 and a method 500 for leveling the work surface 104. The reclaimed material left uneven by the pair of rear ground engaging members 112 behind the rotary mixer 100 may be leveled by the implement 122 coupled to the attachment device 120 associated with the system 102. The attachment device 120 and the implement 122 may be coupled to the frame 106 of the rotary mixer 100 as and when required. Further, the actuators 182 associated with the system 102 may also be fluidly coupled to the hydraulic system 184 of the rotary mixer 100. The attachment device 120 is designed in such a way that any conventional implement may be coupled to the attachment device 120.

The method 500 of leveling the work surface 104 may be described in detail in various steps. The work surface 104 includes the reclaimed material prepared by the mixing chamber 114 of the rotary mixer 100. At step 502, the method 500 includes coupling the attachment device 120 to the frame 106 of the rotary mixer 100. The attachment device 120 is detachably coupled to the frame 106 via the fastening members 134. The plurality of holes 146 in the base member 140 may be aligned with the plurality of holes 132 in the mounting member 126. Further, the first surface 142 of the base member 140 may be aligned to abut the surface 130 of the mounting member 126. The fastening members 134 may be further inserted from the second surface 144 of the base member 140 to engage with the plurality of holes 132 in the mounting member 126.

In various embodiments, one or more spacers may be disposed between the mounting member 126 and the base member 140 such that position of the attachment device 120 may be extended axially along the rotary mixer 100 relative to the frame 106. Further, such axial extension of the attachment device 120 may ensure that the attachment device 120 may not be disturbed with the axle 128 of the rear ground engaging members 112. The link members 151 and the actuators 182 may be further coupled to the base member 140.

The method 500 further includes fluidly coupling the one or more actuators 182 with the hydraulic system 184 of the rotary mixer 100. The control valves 188 and the various hydraulic elements of the hydraulic system 184 may be preassembled in the rotary mixer 100. The actuators 182 may be coupled to the hydraulic system 184 via one or more fluid pipes or hoses.

At step 504, the method 500 includes coupling the implement 122 to the attachment device 120. It may be contemplated that the one or more link members 151 may be kept at the first position ‘P1’ while coupling the implement 122 with the attachment device 120. In the first position ‘P1’, the piston rods 192 of the actuators 182 may be in the retracted position.

At step 506, the method 500 includes actuating the attachment device 120 between the first position ‘P1’ and the second position ‘P2’ via the one or more actuators 182. During operation of the rotary mixer 100, the control levers corresponding to the control valves 188 may be actuated by the operator. Upon actuation, the actuators 182 may fluidly communicate with the hydraulic system 184 such that the piston rods 192 move to the extended position. In the extended position, the work tool 123 of the implement 122 may abut the work surface 104. The control valves 188 may be actuated to control flow of fluid such that the attachment device 120 may be located at any position between the first position ‘P1’ and the second position ‘P2’ depending on a thickness of the work surface 104 to be leveled.

With the system 102 and the method 500, the reclaimed material left uneven by the rear ground engaging members 112 of the rotary mixer 100 may be leveled without requiring additional rotary mixer equipment or human effort. Hence, a transportation cost for the additional machine equipment and/or additional labor cost may be avoided. As the work surface 104 is leveled immediately after the reclamation of the work surface 104, a compactor machine may follow the rotary mixer 100 to compact the work surface 104. Therefore, productivity of the field operation may be increased. Further, the operator may quickly and comfortably couple the attachment device 120 to the frame 106 as the base member 140 and the link members 151 may be separately coupled to each other one by one.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

1. A system associated with a rotary mixer, the rotary mixer comprises a mixing chamber and a rotor rotatably disposed within the mixing chamber for reclaiming material from a work surface, the system comprising:
an attachment device configured to be detachably coupled to a frame of the rotary mixer;
an actuator configured to be coupled between the attachment device and the frame, the actuator further configured to move the attachment device between a first position and a second position relative to the frame; and
an implement detachably coupled to the attachment device, the implement configured to be in contact with the work surface in the second position of the attachment device to level the reclaimed material left behind the rotary mixer during operation of the rotary mixer.

2. The system of claim 1, wherein the attachment device comprises:
a base member configured to be coupled to the frame of the rotary mixer; and
one or more link members pivotally coupled to the base member, the one or more link members configured to couple to the implement.

3. The system of claim 2, wherein the base member comprises a plurality of holes configured to receive a plurality of fastening members therethrough, the fastening members configured to couple the base member to the frame of the rotary mixer.

4. The system of claim 3, wherein the plurality of holes of the base member is configured to align with a plurality of holes defined in the frame, the holes in the frame configured to engage with the fastening members.

5. The system of claim 2, wherein the actuator is coupled between the base member and the one or more link members, and wherein the actuator is configured to move the one or more link members between the first position and the second position.

6. The system of claim 1, wherein the actuator is configured to be in fluid communication with a hydraulic system of the rotary mixer.

7. The system of claim 6, wherein the hydraulic system comprises a control valve fluidly disposed between the actuator and a reservoir, the control valve configured to selectively allow flow of fluid from the reservoir to the actuator to move the one or more link members between the first position and the second position based on an input from an operator

8. The system of claim 6, wherein the actuator is a double acting cylinder.

9. The system of claim 1, wherein the implement is selected from one of a leveling blade and a roller.

10. A rotary mixer having a mixing chamber and a plurality of rotor rotatably disposed within the mixing chamber for reclaiming material from a work surface, the rotary mixer comprising:
a frame;
an attachment device detachably coupled to the frame, the attachment device configured to detachably couple to an implement; and
an actuator configured to be coupled between the attachment device and the frame, the actuator further configured to move the attachment device between a first position and a second position relative to the frame;
wherein the implement is configured to be in contact with the work surface in the second position of the attachment device to level the reclaimed material left behind the rotary mixer during operation of the rotary mixer.

11. The rotary mixer of claim 10, wherein the attachment device comprises:
a base member configured to be coupled to the frame of the rotary mixer; and
one or more link members pivotally coupled to the base member, the one or more link members configured to couple to the implement.

12. The rotary mixer of claim 11, wherein the base member comprises a plurality of holes configured to receive a plurality of fastening members therethrough, the fastening members configured to couple the base member to the frame of the rotary mixer.

13. The rotary mixer of claim 12, wherein the plurality of holes of the base member is configured to align with a plurality of holes defined in the frame, the holes in the frame configured to engage with the fastening members.

14. The rotary mixer of claim 11, wherein the actuator is coupled between the base member and the one or more link members, and wherein the actuator is configured to move the one or more link members between the first position and the second position.

15. The rotary mixer of claim 10, wherein the actuator is configured to be in fluid communication with a hydraulic system of the rotary mixer.

16. The rotary mixer of claim 15, wherein the hydraulic system comprises a control valve fluidly disposed between the actuator and a reservoir, the control valve configured to selectively allow flow of fluid from the reservoir to the actuator to move the one or more link members between the first position and the second position based on an input from an operator.

17. The rotary mixer of claim 15, wherein the actuator is a double acting cylinder.

18. The rotary mixer of claim 10, wherein the implement is selected from one of a leveling blade and a roller.

19. A method of leveling a work surface prepared by a rotary mixer, the rotary mixer comprises a mixing chamber and a rotor rotatably disposed within the mixing chamber for reclaiming material from the work surface, the method comprising:
coupling an attachment device to a frame of the rotary mixer, wherein the attachment device is detachably coupled to the frame;
coupling an implement to the attachment device, wherein the implement is detachably coupled to the attachment device; and
actuating the attachment device to move between a first position and a second position via an actuator, wherein in the second position, the implement is configured to be in contact with the work surface to level the reclaimed material left behind the rotary mixer during operation of the rotary mixer.

20. The method of claim 19 further comprising:
coupling the actuator with a hydraulic system of the rotary mixer; and
supplying fluid to the actuator to move the attachment device between the first position and the second position.
